(19) United States
(12) Patent Application Publication
(10) Pub. No.: US 2006/0115156 A1
(43) Pub. Date: Jun. 1, 2006

(54) Image recognizing system, an image recognizing method, a machine readable medium storing thereon, and a computer program for recognizing images

(75) Inventors: Kazuki Nakajima, Tokyo (JP); Kazuo Shiota, Tokyo (JP)

Correspondence Address: BIRCH STEWART KOLASCH & BIRCH, PO BOX 747, FALLS CHURCH, VA, 22040-0747, US

(73) Assignee: FUJI PHOTO FILM CO. LTD

(21) Appl. No.: 11/285,351

(22) Filed: Nov. 23, 2005

(30) Foreign Application Priority Data
Nov. 26, 2004 (JP) 2004-342989

(51) Int. Cl. G06K 9/46

(52) U.S. Cl. 382/190

(57) ABSTRACT

An image recognizing system for recognizing an object included in an image is provided, wherein the image recognizing system includes: a feature amount database for storing a feature amount representing a feature of each of a plurality of objects in a corresponding manner; an object recognizing unit for recognizing an object included in the image on the basis of the feature amounts stored in the feature amount database; and a feature amount extracting unit for, in case an object included in the image is recognized by the object recognizing unit, extracting another feature amount representing a feature of the object different from a feature amount which is stored in the feature amount database and corresponds to the object from the image, wherein the object recognizing unit recognizes the object included in the image on the basis of another feature extracted by the feature amount extracting unit.

### CROSS REFERENCE TO RELATED APPLICATION

The present application claims priority from a Japanese Patent Application No. JP 2004-342989 filed on Nov. 26, 2004, the contents of which are incorporated herein by reference.

### BACKGROUND OF THE INVENTION

1. Field of the Invention

The present invention relates to an image recognizing system, an image recognizing method, and a machine readable medium storing thereon a computer program for recognizing images. More particularly, the present invention relates to an image recognizing system, an image recognizing method, and a machine readable medium storing thereon a computer program for recognizing images, which recognize an object included in an image.

2. Related Art

Conventionally, an image recognizing system for recognizing a person included in an image on the basis of a face image of the person and the like is known as disclosed, for example, in Japanese Patent Application Laid-Open No. 2001-273496.

However, for the conventional image recognizing system, a success rate of recognition changes largely according to an angle, image capturing conditions, and the like of an image to be recognized. For example, in case of recognizing a person on the basis of a face image of the person, the person may not be recognized with sufficient accuracy if an image is captured with an angle in which the face of the person is hidden from sight or the facial expression of the person changes largely.

### SUMMARY OF THE INVENTION

Therefore, it is an object of the present invention to provide an image recognizing system, an image recognizing method, and a machine readable medium storing thereon a computer program for recognizing images, which are capable of overcoming the above drawbacks accompanying the conventional art. The above and other objects can be achieved by combinations described in the independent claims. The dependent claims define further advantageous and exemplary combinations of the present invention.

According to the first aspect of the present invention, an image recognizing system for recognizing an object included in an image includes: a feature amount database for storing a feature amount representing a feature of each of a plurality of objects in a corresponding manner; an object recognizing unit for recognizing an object included in the image on the basis of the feature amounts stored in the feature amount database; and a feature amount extracting unit for, in case an object included in the image is recognized by the object recognizing unit, extracting another feature amount representing a feature of the object different from a feature amount which is stored in the feature amount database and corresponds to the object from the image, wherein the object recognizing unit recognizes the object included in the image on the basis of another feature extracted by the feature amount extracting unit.

In case the object included in the image is recognized by the object recognizing unit, the feature amount extracting unit may extract another feature amount representing a feature of the object from a part of the object different from that showing the feature amount which is stored in the feature amount database and corresponds to the object The feature amount extracting unit may output another feature amount extracted from the image with the date of the image being captured in a corresponding manner, and the object recognizing unit may recognize the object on the basis of another feature only in case difference between the image capturing date corresponding to another feature extracted by the feature amount extracting unit and an image capturing date of the image is smaller than a predetermined available period. The available period may be different according to the kind of another feature extracted by the feature amount extracting unit.

In case a feature amount extracted from one object by the feature amount extracting unit is similar to a feature amount extracted from another object by the feature amount extracting unit, the object recognizing unit may recognize the one object included in the image without referring to the feature amount extracted from the one object. The feature amount database may store a face image as a feature amount representing a feature of each of a plurality of persons for the plurality of persons in a corresponding manner, and the object recognizing unit may recognize a person included in the image on the basis of the face image of each of the plurality of persons stored in the feature amount database.

According to the second aspect of the present invention, an image recognizing method for recognizing an object included in an image is provided, wherein a feature amount database stores a feature amount representing a feature of each of a plurality of objects in a corresponding manner, the image recognizing method includes: an object recognizing step of recognizing an object included in the image on the basis of the feature amounts stored in the feature amount database; and a feature amount extracting step of, in case an object included in the image is recognized in the object recognizing step, extracting another feature amount representing a feature of the object different from a feature amount which is stored in the feature amount database and corresponds to the object from the image, and in the object recognizing step, the object included in the image is recognized on the basis of another feature extracted in the feature amount extracting step.

According to the third aspect of the present invention, a machine readable medium storing thereon an image recognizing program for making a computer function as an image recognizing system for recognizing an object included in an image is provided, wherein the computer includes: a feature amount database for storing a feature amount representing a feature of each of a plurality of objects in a corresponding manner; an object recognizing unit for recognizing an object included in the image on the basis of the feature amounts stored in the feature amount database; and a feature amount extracting unit for, in case an object included in the image is recognized by the object recognizing unit, extracting another feature amount representing a feature of the object different from a feature amount which is stored in the feature amount database and corresponds to the object from the image, and the object recognizing unit recognizes the object included in the image on the basis of another feature extracted by the feature amount extracting unit.

The summary of the invention does not necessarily describe all necessary features of the present invention. The present invention may also be a sub-combination of the features described above.

According to the present invention, it is possible to certainly recognize an object in an image regardless of a state of the object being placed in the image.

### BRIEF DESCRIPTION OF THE DRAWINGS

FIG. 1 is a block diagram showing an example of a functional configuration of an image recognizing system 10 according to an embodiment of the present invention.

FIG. 2 shows an example of the feature amount database 110 according to an embodiment of the present embodiment.

FIG. 3 shows an example of an image input by an image inputting unit 100 according to an embodiment of the present invention.

FIG. 4 is a flowchart showing an example of a process flow of an image recognizing method using the image recognizing system 10 according to an embodiment of the present invention.

FIG. 5 is a block diagram showing an example of a hardware configuration of a computer 1500 according to an embodiment of the present invention.

### DETAILED DESCRIPTION OF THE INVENTION

The invention will now be described based on the preferred embodiments, which do not intend to limit the scope of the present invention, but exemplify the invention. All of the features and the combinations thereof described in the embodiment are not necessarily essential to the invention.

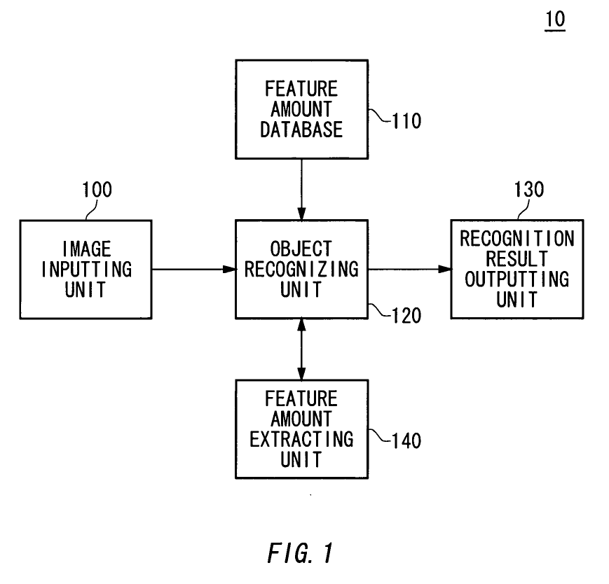

FIG. 1 is a block diagram showing an example of a functional configuration of an image recognizing system 10 according to an embodiment of the present invention. The image recognizing system 10 recognizes an object included in an image. Further, although the image recognizing system 10 for recognizing a person included in an image is used as an example in the following, the image recognizing system 10 is not limited to the example and may recognize an object other than a person. In case images captured, for example, by a digital camera are classified so as to be managed as an electronic album, the image recognizing system 10 may be used to identify a person included in the image. Further, the image recognizing system 10 may be used to identify a person included in an image captured by a digital camera, for example, for the so-called biometric authentication. Further, the image recognizing system 10 may perform recognition of an object in a still picture or a moving picture and, in case of a moving picture, perform recognition of an object for at least a part of frame images included in the moving picture.

It is an object of the image recognizing system according to an embodiment of the present invention to certainly recognize an object included in an image, regardless of a state of the object being placed in the image.

The image recognizing system 10 includes an image inputting unit 100, a feature amount database 110, an object recognizing unit 120, a recognition result outputting unit 130, and a feature amount extracting unit 140. The image inputting unit 100 inputs an image which should be recognized by the image recognizing system 10. The image inputting unit 100 may be a storage using a magnetic recording medium and a semiconductor recording medium, or a network interface which can exchange image data via a network such as the internet. Further, the image inputting unit 100 outputs the image to the object recognizing unit 120.

For a plurality of objects, the feature amount database 110 stores feature amounts each of which represents a feature of each of the plurality of objects in a corresponding manner. For example, in case the image recognizing system 10 recognizes persons included in images, the feature amount database 110 may store a face image of each of a plurality of persons as a feature amount representing a feature of the person. On the basis of the feature amount of each object stored in the feature amount database 110, the object recognizing unit 120 recognizes an object included in an image input by the image inputting unit 100. Then, the object recognizing unit 120 outputs the recognition result to the recognition result outputting unit 130.

The recognition result outputting unit 130 outputs a result of recognizing an object included in an image input by the image inputting unit 100, which is received from the image recognizing unit 120, to provide the result to a user. For example, in case the recognition result outputting unit 130 makes good recognition, it may display the input image and the name of a person who is the object by using a display apparatus provided in the image recognizing system 10. Further, for example, in case the recognition result outputting unit 130 makes good recognition, it may record the name of the person which is the object on an image file showing the input image as tag information based on the Exif (Exchangeable image file) format. Further, for example, in case the recognition result outputting unit 130 makes good recognition, it may store the image file showing the input image in directories each of which is provided for each person included in the image.

In case an object included in the image input by the image inputting unit 100 is recognized by the object recognizing unit 120, the feature amount extracting unit 140 extracts a feature amount representing a feature of the object, which is different from the feature amount of the object stored in the feature amount database 110, from the image. For example, in case a person included in the input image is recognized, the feature amount extracting unit 140 extracts a feature amount, that is, the shape of his/her dress, which is different from a face image of the person stored in the feature amount database 110 from the image. Then, on the basis of the feature amount extracted by the feature amount extracting unit 140, the object recognizing unit 120 recognizes an object included in an image newly input from the image inputting unit 100.

For example, for an image recognizing system which recognizes a person on the basis of a face image, sometimes it is difficult to extract a face image of a person which makes the person sufficiently recognized from a partial image showing the person included in an image to be recognized if the image is captured with a undesirable angle or under undesirable image capturing conditions. In this case, a conventional image recognizing system cannot recognize the person. However, according to the image capturing system 10 of the embodiment of the present invention, in case person recognition based on a face image is successful for an input image, it is possible to extract a feature amount different from a face image from a partial image included in the image which shows the person and hold the feature amount as a feature amount which represents a feature of the person. By this, in case of performing person recognition for the input image thereafter, it is possible to recognize the person on the basis of another feature amount once held even if a face image which makes the person sufficiently recognized cannot be extracted from a partial image showing the person included in the image. Consequently, by using the image recognizing system 10 according to the embodiment of the present invention, it is possible to certainly recognize a person in an input image regardless of a state of the person being placed in the image.

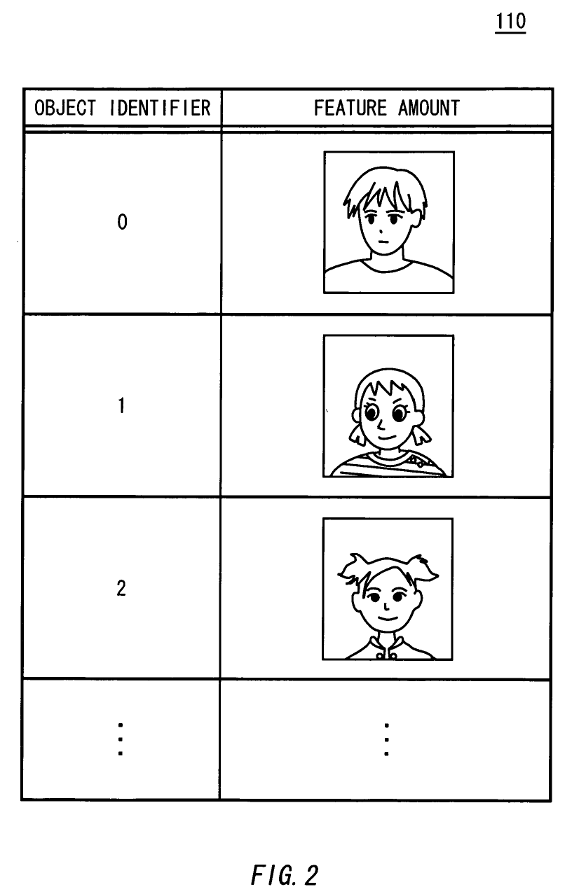

FIG. 2 shows an example of the feature amount database 110 according to an embodiment of the present embodiment. For each of a plurality of persons, the feature amount database 110 stores an object identifier for identifying the person and a feature amount of the person in a corresponding manner. Here, the object identifier may be a value uniquely determined for each object when a feature amount of the object is stored in the feature amount database 110, for example. Further, although according the object identifier is represented by numbers in the present figure, it may be a string such as the name of a person. Further, in the present figure, the feature amount database 110 stores a face image of a person who is an object as a feature amount of the object. Here, instead of a face image, the feature amount database 110 may store one of various feature amounts such as a contour shape of a face, shapes of distinguishing parts of the face such as eyes, a nose, and a mouth, a position of each of the parts in the whole face, and a positional relationship between the parts.

Then, the object recognizing unit 120 recognizes a person included in the image input by the image inputting unit 100 on the basis of the face image of each of the plurality of persons, which is stored in the feature amount database 110. For example, the object recognizing unit 120 detects an object included in the input image by performing a known image processing, such as a contour extraction processing, a color distribution analysis processing, etc., on the image. Then, in case the object is a person, the object recognizing unit 120 detects feature amounts unique to a human's face from a partial image showing the detected object and thus detects a partial image showing the face of the object from the partial image showing the detected object. Then, the object recognizing unit 120 compares the detected partial image showing the face with each of the face images stored for the plurality of persons in the feature amount database 110 shown in FIG. 2. Then, in case the detected partial image showing the face is similar to a face image stored in the feature amount database 110 by more than a reference similarity, the object recognizing unit 120 recognizes the object detected from the image to be a person corresponding to the face image in the feature amount database 110 and detects an object identifier representing the person. Then, the object recognizing unit 120 outputs the detected object identifier to the recognition result outputting unit 130 as a recognition result.

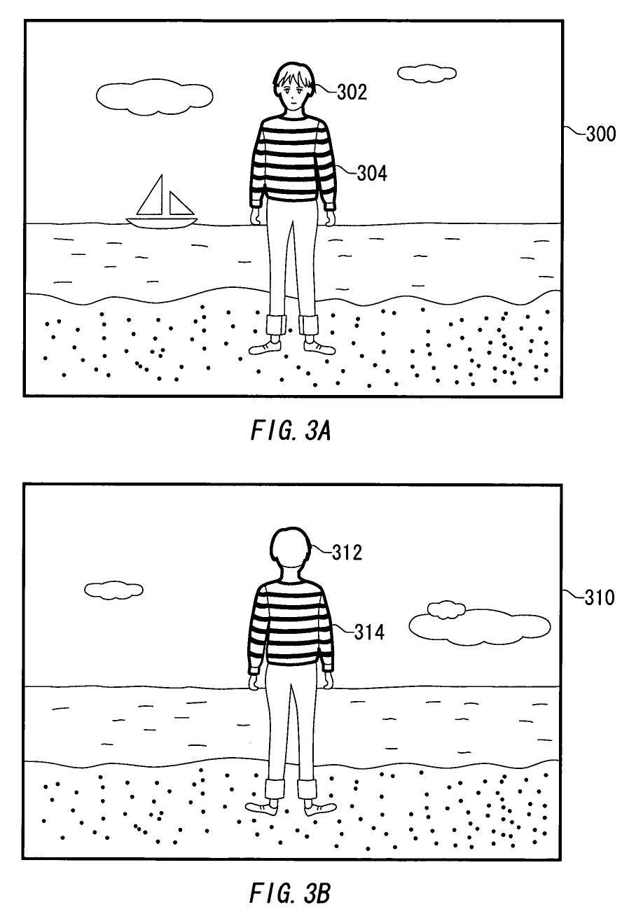

FIG. 3 shows an example of an image input by an image inputting unit 100 according to an embodiment of the present invention. According to the present example, the image inputting unit 100 inputs an image 310 after inputting an image 300. First, a process in case the image 300 is input is described. The object recognizing unit 120 detects a partial image 302 showing the face from a partial image showing a person included in the image 300. Then, the object recognizing unit 120 compares the detected partial image 302 with a face image of every person stored in the feature amount database 110 and thus recognizes the person included in the image 300. Then, the object recognizing unit 120 outputs an object identifier “0 ” which identifies the person as a recognition result.

Further, in case an object included in the image is recognized by the object recognizing unit 120, the feature amount extracting unit 140 extracts a feature of the object other than a feature amount stored in the feature amount database 110 which corresponds to the object from a part of the object different a part showing the feature amount. For example, a feature amount extracting unit 140 extracts a feature amount representing a shape of dress which he puts on from a partial image 304 which is a part different from the partial image 302 showing the face as another feature amount of the image 300.

Then, a process in case the image 310 is input is described. Since the image 310 includes a person but the partial image 312 showing the head of the person does not include a face image of the person, the object recognizing unit 120 cannot recognize the person for the image 310 on the basis of the face images of persons stored in the feature amount database 110. However, the object recognizing unit 120 recognizes the person included in the image 310 to be the same as the person included in the image 300 on the basis of the feature amount representing the shape of dress, which is different from the face image, extracted from the partial image 304 included in the image 300 by the feature amount extracting unit 140 and the partial image 314 included in the image 310. By this, the object recognizing unit 120 outputs the object identifier “0 ” for identifying the person included in the image 310, which is the same as the recognition result of the image 300, as a result of recognizing the person included in the image 310.

As above, by extracting another feature from a part different from a part showing the feature amount stored in the feature amount database 110, it is possible to decrease possibility of both of the feature amount stored in the stored in the feature amount database 110 and another feature amount extracted by the feature amount extracting unit 140 not being included at the same time in the input image. Consequently, according to the image recognizing system 10 of the embodiment of the present invention, it is possible to recognize a person included in an image more certainly.

Further, according to the above description, in case a person cannot be recognized on the basis of a feature amount stored in the feature amount database 110, the object recognizing unit 120 recognizes the person by using another feature extracted by the feature amount extracting unit 140. However, the object recognizing unit 120 may recognize the person by using both of the feature amount stored in the feature amount database 110 and another feature extracted by the feature amount extracting unit 140 at the same time. By this, it is possible to improve accuracy of recognizing the person.

Further, the feature amount extracting unit 140 may output another feature amount extracted from the input image along with date and time of capturing the image in a corresponding manner. In this case, in case of intending to recognize a person included in the input image on the basis of another feature amount extracted by the feature amount extracting unit 140, the object recognizing unit 120 recognizes the person on the basis of another feature amount only if difference between image capturing date and time corresponding to the extracted feature and date and time of capturing the input image is shorter than a predetermined available period.

For example, in case another feature extracted by the feature amount extracting unit 140 is a shape of dress which the person puts on, probably the person does not put on the dress in an image captured on a date different from the date when the feature is extracted. Consequently, at a point of time far from date of time of capturing the image from which another feature amount is extracted, correspondence between another feature and the person probably fails. However, according to the image recognizing system 10 of the embodiment of the present invention, it is possible to improve a degree of recognition because person recognition can be performed without referring to another feature amount for an image captured more than the available period before or after the date and time of capturing the image from which another feature amount is extracted.

Further, the available period may include a condition such as “the same day” or “the same year” in case of comparing the dates as well as a time interval such as one (1) day or one (1) month.

Further, for another feature extracted by the feature amount extracting unit 140, the available period described above may be different according to the kind of another feature. Here, the kind of feature amount may be determined, for example, so as to correspond to a part showing the feature amount of an object such as the hair, the dress, and the like. Further, the available period which is different according to the kind of feature amount may be determined, for example, by a user as one (1) week in case of the hair of a person or one (1) day in case of the dress.

The length of a period during which correspondence between another feature extracted and the person can be expected is sometimes different according to the kind of another feature. However, according to the image recognizing system 10 of the embodiment of the present invention, it is possible to change the available period of another feature extracted according to the kind of the feature. Therefore, it is possible to recognize the person more certainly and with higher accuracy by determining a longer available period for the kind of feature amount of which correspondence to the person is expected for a longer time.

Further, in case a feature amount extracted by the feature amount extracting unit 140 for one person included in an input image is similar to that for another person by more than a reference similarity, the one person may be recognized without referring the feature amount extracted for the one person.

Sometimes, any feature amount extracted for one person is not unique to the one person and similar to a feature amount extracted for another person. In this case, if recognition is performed on the basis of the extracted feature amount, it is impossible to distinguish the one person from another person. However, according to the image recognizing system 10 of the embodiment of the present invention, in case a feature amount extracted from one person is similar to a feature amount which has been previously extracted from another person, it is possible to perform person recognition without referring to the extracted feature amount. By this, it is possible to improve accuracy of recognition of a person included in an image.

Further, in this case, the object recognizing unit 120 may perform recognition of a person included in an image by using none of the feature extracted from the one person and the feature amount which has been previously extracted from another person.

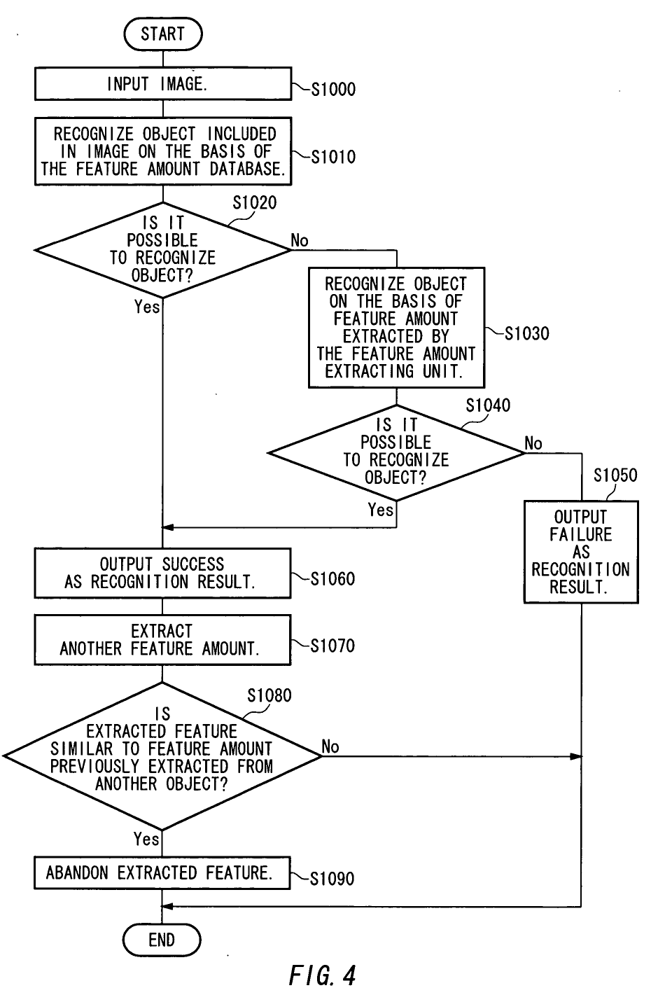

FIG. 4 is a flowchart showing an example of a process flow of an image recognizing method using the image recognizing system 10 according to an embodiment of the present invention. First, the image inputting unit inputs an image which should be recognized (S1000). Then, the object recognizing unit 120 recognizes an object included in the input image on the basis of a feature amount of every object stored in the feature amount database 110 (S1010). Here, the object recognizing unit 120 judges whether or not it is possible to recognize an object (S1020). In case of judging that it is impossible to recognize an object (S1020: No), the object recognizing unit 120 recognizes the object included in the input image on the basis of a feature amount extracted by the feature amount extracting unit 140 which is different from the feature amount stored in the feature amount database 110 (S1030). Here, the object recognizing unit 120 judges whether or not it is possible to recognize an object once again (S1040). In case the object recognizing unit 120 judges that it is impossible to recognize an object (S1040: No), the recognition result outputting unit 130 outputs “failure” as a object recognition result for the input image (S1050).

In the meantime, in case the object recognizing unit 120 judges that the object was recognized (S1020: Yes or S1040: No), the recognition result outputting unit 130 outputs “success” as a object recognition result for the input image (S1060). Then, the feature amount extracting unit 140 extracts another feature amount representing a feature of the object included in the image which is different from the feature amount stored in the feature amount database 110 (S1070) . Here, the feature amount extracting unit 140 judges whether or not another extracted feature amount is similar to a feature amount which has been previously extracted from another object (S1080). Then, in case it is judged that another extracted feature is not similar to the feature amount previously extracted from another object (S1080: No), the feature amount extracting unit 140 makes the object recognizing unit 120 recognize the object included in the input image on the basis of the extracted feature amount in S1030. In the meantime, in case it is judged that another extracted feature is similar to the feature amount previously extracted from another object (S1080: Yes), the feature amount extracting unit 140 abandons the extracted feature amount (S1090). Further, in this case, the feature amount extracting unit 140 may also abandon the feature amount previously extracted from another object.

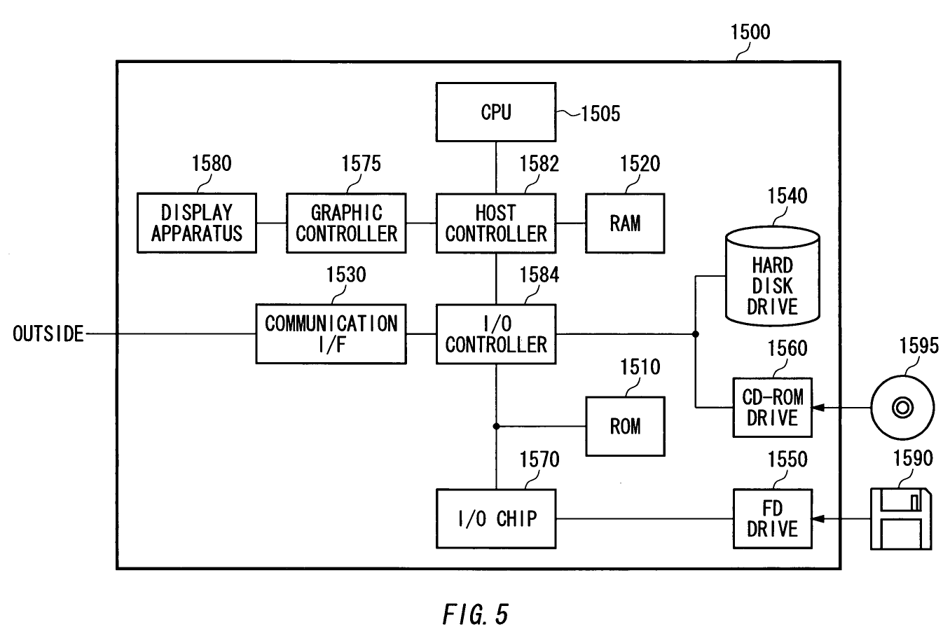

FIG. 5 is a block diagram showing an example of a hardware configuration of a computer 1500 according to the embodiment of the present invention. The computer 1500 according to the embodiment of the present invention includes a CPU peripheral part comprising a CPU 1505, a RAM 1520, a graphic controller 1575, and a display apparatus 1580 which are connected with each other by a host controller 1582, an input and output part comprising a communication interface 1530 connected to the host controller 1582 by an input and output controller 1584 (“I/O controller 1584”), a hard disk drive 1540, and a CD-ROM drive 1560, and a legacy input and output part comprising a ROM 1510 connected to the I/O controller 1584, a flexible disk drive 1550, and an input and output chip 1570 (“I/O chip 1570”).

The host controller 1582 connects the RAM 1520 with the CPU 1505 having access to the RAM 1520 at a high transmission rate and the graphic controller 1575. The CPU 1505 operates and performs control of each part on the basis of programs stored in the ROM 1510 and the RAM 1520. The graphic controller 1575 acquires image data which is generated on a frame buffer provided in the RAM 1520 by the CPU 1505, etc. and displays it on the display apparatus 1580. Instead, the graphic controller 1575 may include a frame buffer storing an image data generated by the CPU 1505, etc. therein.

The I/O controller 1584 connects the host controller 1582 with the communication interface 1530, which is a relatively high-speed I/O apparatus, the hard disk drive 1540, and the CD-ROM drive 1560. The communication interface 1530 communicates with another apparatus via a network. The hard disk drive 1540 stores a program and data used by the CPU 1505 in the computer 1500. The CD-ROM drive 1560 retrieves a program or data from a CD-ROM 1595 and provides the hard disk drive 1540 with it via the RAM 1520.

Further, the I/O controller 1584 is connected with the ROM 1510 and a relatively low-speed I/O apparatus such as the flexible disk drive 1550 and the I/O chip 1570. The ROM 1510 stores a program executed by the CPU 1500 when the computer 1500 starts to operate, a program depending on the hardware of the computer 1500, and the like. The flexible disk drive 1550 retrieves a program or data from a flexible disk 1590 and provides the hard disk drive 1540 with it via the RAM 1520. The I/O chip 1570 connects the flexible disk drive 1550 with various I/O apparatus via a parallel port, a serial port, a keyboard port, a mouse port, and the like.

An image recognizing program provided to the hard disk drive 1540 via the RAM 1520 is stored in a recording medium such as the flexible disk 1590, the CD-ROM 1595, or an IC-card and provided by a user. The image recognizing program is retrieved from the recording medium, installed on the hard disk drive 1540 in the computer 1500 via the RAM 1520, and executed on the CPU 1505. The image recognizing program installed and executed on the computer 1500 makes the CPU 1505 and the like operate and the computer 1500 function as the image recognizing system described with respect to FIGS. 1 to 4.

The program described above may be stored in a recording medium of the outside. An optical recoding medium such as a DVD, a PD, etc., a magneto-optical recording medium such as an MD, a tape medium, and a semiconductor memory such as an IC card can be used as the recoding medium in addition to the flexible disk 1590 and the CD-ROM 1595. Further, a storing apparatus such as a hard disk or a RAM provided in a server system connected with a dedicated communication network and internet may be used as the recording medium and may provide the computer 1500 with the program through the network.

Although the present invention has been described by way of exemplary embodiments, it should be understood that those skilled in the art might make many changes and substitutions without departing from the spirit and the scope of the present invention which is defined only by the appended claims.

What is claimed is:

1. An image recognizing system for recognizing an object included in an image comprising:
a feature amount database for storing a feature amount representing a feature of each of a plurality of objects in a corresponding manner;
an object recognizing unit for recognizing an object included in the image on the basis of the feature amounts stored in said feature amount database; and
a feature amount extracting unit for, in case an object included in the image is recognized by said object recognizing unit, extracting another feature amount representing a feature of the object different from a feature amount which is stored in said feature amount database and corresponds to the object from the image,
wherein said object recognizing unit recognizes the object included in the image on the basis of said another feature extracted by said feature amount extracting unit.

2. The image recognizing system as claimed in claim 1, wherein
in case the object included in the image is recognized by said object recognizing unit, said feature amount extracting unit extracts another feature amount representing a feature of the object from a part of the object different from that showing the feature amount which is stored in said feature amount database and corresponds to the object.

3. The image recognizing system as claimed in claim 1, wherein
said feature amount extracting unit outputs said another feature amount extracted from the image with the date of the image being captured in a corresponding manner, and
said object recognizing unit recognizes the object on the basis of said another feature only in case difference between the image capturing date corresponding to said another feature extracted by said feature amount extracting unit and an image capturing date of the image is smaller than a predetermined available period.

4. The image recognizing system as claimed in claim 3, wherein
the available period is different according to the kind of said another feature extracted by said feature amount extracting unit.

5. The image recognizing system as claimed in claim 1, wherein
in case a feature amount extracted from one object by said feature amount extracting unit is similar to a feature amount extracted from another object by said feature amount extracting unit, said object recognizing unit recognizes said one object included in the image without referring to said feature amount extracted from said one object.

6. The image recognizing system as claimed in claim 1, wherein
said feature amount database stores a face image as a feature amount representing a feature of each of a plurality of persons for the plurality of persons in a corresponding manner, and
said object recognizing unit recognizes a person included in the image on the basis of the face image of each of the plurality of persons stored in said feature amount database.

7. An image recognizing method for recognizing an object included in an image, wherein
a feature amount database stores a feature amount representing a feature of each of a plurality of objects in a corresponding manner,
the image recognizing method comprises:
an object recognizing step of recognizing an object included in the image on the basis of the feature amounts stored in the feature amount database; and
a feature amount extracting step of, in case an object included in the image is recognized in said object recognizing step, extracting another feature amount representing a feature of the object different from a feature amount which is stored in the feature amount database and corresponds to the object from the image, and
in said object recognizing step, the object included in the image is recognized on the basis of said another feature extracted in said feature amount extracting step.

8. A machine readable medium storing thereon an image recognizing program for making a computer function as an image recognizing system for recognizing an object included in an image, wherein the computer comprises:
a feature amount database for storing a feature amount representing a feature of each of a plurality of objects in a corresponding manner;
an object recognizing unit for recognizing an object included in the image on the basis of the feature amounts stored in said feature amount database; and
a feature amount extracting unit for, in case an object included in the image is recognized by said object recognizing unit, extracting another feature amount representing a feature of the object different from a feature amount which is stored in the feature amount database and corresponds to the object from the image, and
said object recognizing unit recognizes the object included in the image on the basis of said another feature extracted by said feature amount extracting unit.
